(19) United States
(12) Patent Application Publication
(10) Pub. No.: US 2008/0163046 A1
(43) Pub. Date: Jul. 3, 2008

(54) METHOD, SYSTEM AND PROGRAM PRODUCT FOR MANAGING CONTROLS WITHIN AN MDI ENVIRONMENT

(76) Inventors: Christopher J. Paul, Durham, NC (US); Andrew L. Schirmer, Andover, MA (US)

Correspondence Address: HOFFMAN WARNICK LLC, 75 STATE ST, 14TH FLOOR, ALBANY, NY, 12207, US

(21) Appl. No.: 11/617,942

(22) Filed: Dec. 29, 2006

(51) Int. Cl. G06F 17/20

(52) U.S. Cl. 715/277

(57) ABSTRACT

Aspects of the present invention provide a solution for managing a multiple document interface (MDI) environment. Specifically, an embodiment of the present invention allows a user, administrator, etc., to create a customized user interface for the user. This interface may include a specification of a location of a particular control, such as a tab, for selecting a window in the MDI. The specification may include a particular control location, such as the right edge of the window; a control location relative to another control; and/or a control location relative to a portion of the window, such as second control from the left side of the window. The interface may also include a customized size for the control.

### FIELD OF THE INVENTION

Aspects of the present invention generally relate to window display. Specifically, aspects of the present invention provide a solution for managing controls in a multiple document interface environment.

### BACKGROUND OF THE INVENTION

In the world of information technology, the manner in which data is displayed is of high importance. Users of a particular application are more comfortable and more efficient when the menus and controls that they use are in a familiar position. For this reason, standards have been formulated for standard user interfaces. These standards may include such features as the file menu being the first menu in a menu bar, followed by the edit menu, and so forth.

However, things become more difficult in a multiple document interface (MDI) environment such as those provided in some applications. Because of the dynamic nature of the MDI environment, solutions that are used in a static environment will not work. This is, in part, because it is not known prior to execution of the application using the MDI environment which windows will be available for use. Because of this, controls, such as tabs, that are associated with windows in an MDI environment very often are arranged haphazardly. This reduces efficiency and comfort of the user when using the particular application.

In view of the foregoing, there exists a need for a solution that overcomes one or more of the shortcomings of the prior art.

### SUMMARY OF THE INVENTION

In general, aspects of the present invention provide a solution for managing a multiple document interface (MDI) environment. Specifically, an embodiment of the present invention allows a user, administrator, etc., to create a customized user interface for the user. This interface may include a specification of a location of a particular control, such as a tab, for selecting a window in the MDI. The specification may include a particular control location, such as the right edge of the window; a control location relative to another control; and/or a control location relative to a portion of the window, such as second control from the left side of the window. The interface may also include a customized size for the control.

A first aspect of the present invention provides a method for managing a multiple document interface environment, comprising: obtaining at least one dynamically generated document window, each document window corresponding to an independently selected document and having an associated control for selecting the document window; obtaining a specified location of the associated control based on the document; and placing the associated control in the specified location.

A second aspect of the present invention provides a system for managing a multiple document interface environment, comprising: a document window obtainer for obtaining at least one dynamically generated document window, each document window corresponding to an independently selected document and having an associated control for selecting the document window; a control customizer for obtaining a specified location of the associated control based on the document; and a custom control renderer for placing the associated control in the specified location.

A third aspect of the present invention provides a program product stored on a computer readable medium for managing a multiple document interface environment, the computer readable medium comprising: program code for obtaining at least one dynamically generated document window, each document window corresponding to an independently selected document and having an associated control for selecting the document window; program code for obtaining a specified location of the associated control based on the document; and program code for placing the associated control in the specified location.

A fourth aspect of the present invention provides a method for deploying a system for managing a multiple document interface environment, comprising: providing a computer infrastructure being operable to: obtain at least one dynamically generated document window, each document window corresponding to an independently selected document and having an associated control for selecting the document window; obtain a specified location of the associated control based on the document; and place the associated control in the specified location.

A fifth aspect of the present invention provides computer software embodied in a propagated signal for managing a multiple document interface environment, the computer software comprising instructions for causing a computer system to perform the following: obtain at least one dynamically generated document window, each document window corresponding to an independently selected document and having an associated control for selecting the document window; obtain a specified location of the associated control based on the document; and place the associated control in the specified location.

A sixth aspect of the present invention provides a method for managing a multiple document interface environment, the method comprising managing a computer infrastructure that performs the process described herein; and receiving payment based on the managing.

Therefore, the present invention provides a method, system, and program product for managing a multiple document interface environment.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative computer infrastructure for managing a multiple document interface environment according to an embodiment of the present invention.

FIG. 2 shows an example of a Multiple Document Interface (MDI) Environment according to one embodiment of the present invention.

FIG. 3 shows a managed MDI environment according to one embodiment of the present invention.

FIG. 4 shows a managed MDI environment according to one embodiment of the present invention.

FIG. 5 shows an illustrative method flow diagram according to one embodiment of the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the present invention provide a solution for managing a multiple document interface (MDI) environment. Specifically, an embodiment of the present invention allows a user, administrator, etc., to create a customized user interface for the user. This interface may include a specification of a location of a particular control, such as a tab, for selecting a window in the MDI. The specification may include a particular control location, such as the right edge of the window; a control location relative to another control; and/or a control location relative to a portion of the window, such as second control from the left side of the window. The interface may also include a customized size for the control.

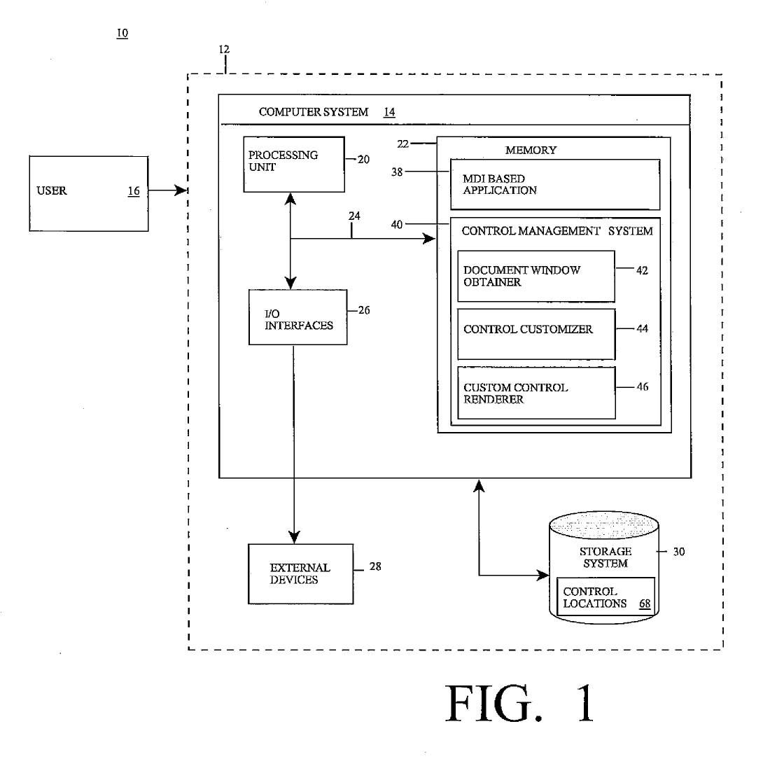

Referring now to FIG. 1, a system 10 for managing a multiple document interface (MDI) environment according to an embodiment of the present invention is shown. Specifically, FIG. 1 depicts a system 10 in which display of controls, such as tabs, in the MDI window can be managed and/or customized by a user 16. User 16 may be the end user of the MDI window, an administrator, or other individual responsible for managing equipment for the end user. This managing may serve to arrange the controls and/or to change the size of the controls to achieve a result that is intended to assist the end user. Locations of the controls may be specified as an absolute location or, in the alternative, relative to another control, position in the window, and/or the like.

As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by a conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to manage a multiple document interface (MDI) environment.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as a control management system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the process of the invention. Moreover, computer system 14 is only representative of various possible computer systems that can include numerous combinations of hardware and/or software. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention. For example, storage system 30 may be used to store control locations 68 after they have been specified by user 16. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

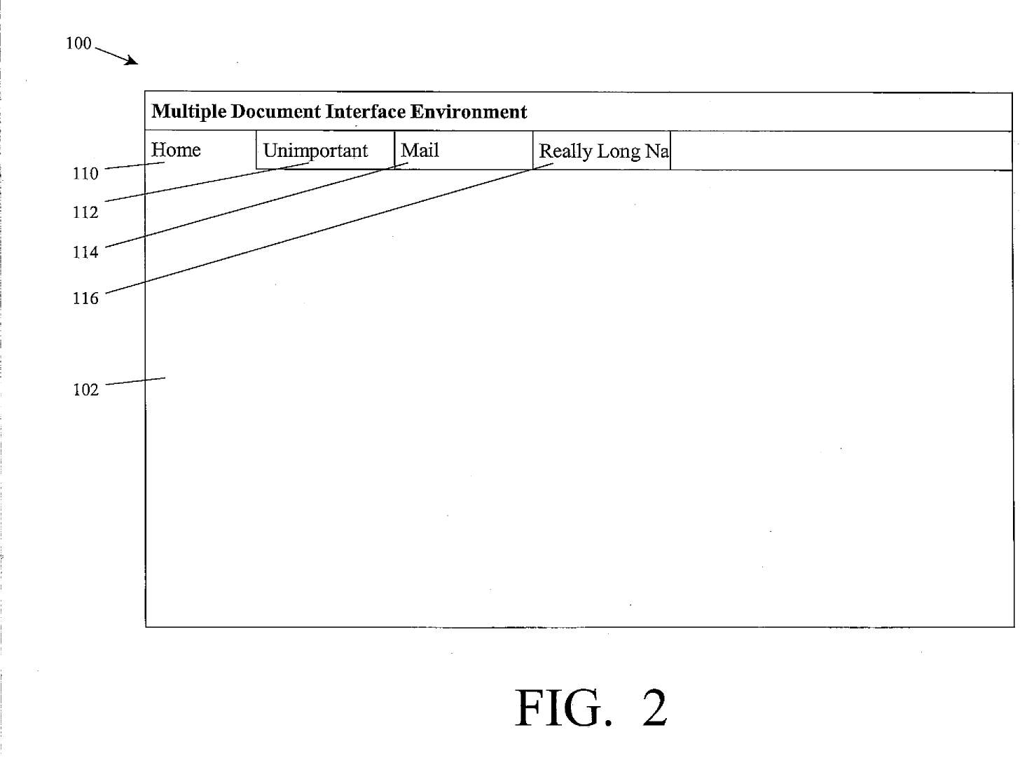

Shown in memory 22 of computer system 14 are an MDI based application 38 and a control management system 40, which is a software program that provides the functions of the present invention. FIG. 2 shows an example of a Multiple Document Interface (MDI) environment 100 generated by MDI based application 38 (FIG. 1). MDI environment 100 includes a number of document windows, such as window 102. Each document window in MDI environment 100 is dynamically generated and corresponds to an independently selected document. A document in MDI environment may comprise a single or multiple pages and may be a web page, mail reader, application interface, database display, spreadsheet, word processor display, or any other type that is now or later discovered to be usable in an MDI environment. Each document window also has an associated control, such as tabs 110, 112, 114 and 116, which is used to select the document window and/or to bring the document window to the forefront of the MDI environment 100 display. As shown, tab 110 is associated with window 102, while tabs 112, 114 and 116 may be activated by user 16 (FIG. 1) to display windows that are not currently visible.

In this environment, the tab 110 of first window 102 to be opened is displayed in the leftmost portion of the window while subsequent tabs 112, 114, 116 are displayed in order of the opening of each window by default. So, in this example, the home 110 window has been opened first, followed by unimportant window having tab 112, mail window having tab 114, the Really Long Name window having tab 116. Notice that in this example, unimportant window tab 112 is in the second to the leftmost position, even though the document corresponding to unimportant window tab 112 may not be as important as another document window, such as the window corresponding to mail window tab 112. Also notice the uniform default size of each of the tabs 110, 112, 114, 116. This default size has caused the name of the really long named window to be truncated to read “Really Long Na” in tab 116.

Referring back to FIG. 1 in conjunction with FIG. 2, control management system 40 provides a system for managing tabs in MDI environment 100. To this extent, control management system 40 includes a document window obtainer 42, a control customizer 44, and a custom control renderer 46.

Document window obtainer 42 obtains a document window 102 in MDI environment 100. Each document window 102 is dynamically generated and corresponds to an independently selected document. Each document window 102 also has an associated control 110, 112, 114, 116 for selecting the document window. In an illustrative environment, the associated control is a tab, however, any control now known or later developed for controlling navigation between windows in MDI environment 100 is envisioned. MDI environment 100 obtained by document window obtainer 42 may be a web browser, or, in the alternative, may be any other type of application that is suitable to be displayed in a MDI environment.

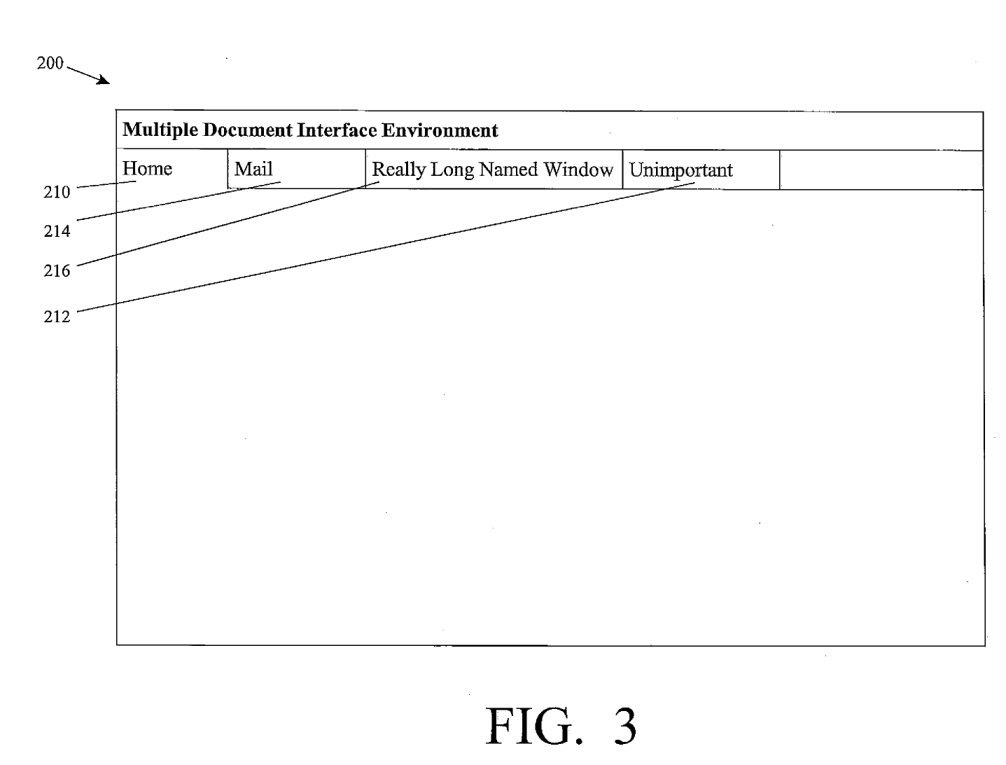

Control customizer 44 enables user 16 to specify maintenance options for a control, such as tabs 210, 212, 214 and 216 (FIG. 3). For example, control customizer 44 may permit user 16 to specify a location of a control that is associated with a particular document window. This location may correspond to an absolute position in the window; may be relative to a starting position, such as the leftmost edge of the window; and/or may be relative to another particular control. In addition, control customizer 44 may permit user 16 to specify a size of the control. To this extent, control customizer 44 may include a graphical user interface or any other method of specifying preferences that is now known or later developed. These maintenance options may be stored as control locations 68 (FIG. 1) in storage system 30 (FIG. 1) using any solution now known or later developed. In addition, an identifier of user 16 for while the maintenance options have been specified may be stored as control locations 68 (FIG. 1) in storage system 30 (FIG. 1) using any solution now known or later developed.

Custom control renderer 46 places and/or renders the control in the manner specified by user 16. For example, custom control renderer 46 may place the associated control in a location that is specified using control customizer 44. Additionally, custom control renderer 46 may render the control to be the size that is specified using control customizer 44. In performing this placement and/or rendering, custom control renderer 46 may retrieve the maintenance options stored as control locations 68 (FIG. 1) in storage system 30 (FIG. 1) and display the control according to the specification. In this way, the associated control may be placed in the specified location and/or be rendered in the specified size each time the control is displayed. Furthermore, custom control renderer 46 may use the stored identifier of user 16 (FIG. 1) to place and/or render a control in one location and/or size for one user and a different location and/or size for a second user. So, for example, the control corresponding to a particular document window may be displayed in the leftmost portion of the MDI environment for one user and the second to the leftmost portion of the MDI environment for another user, regardless of whether the document was opened first, fifth, last, etc.

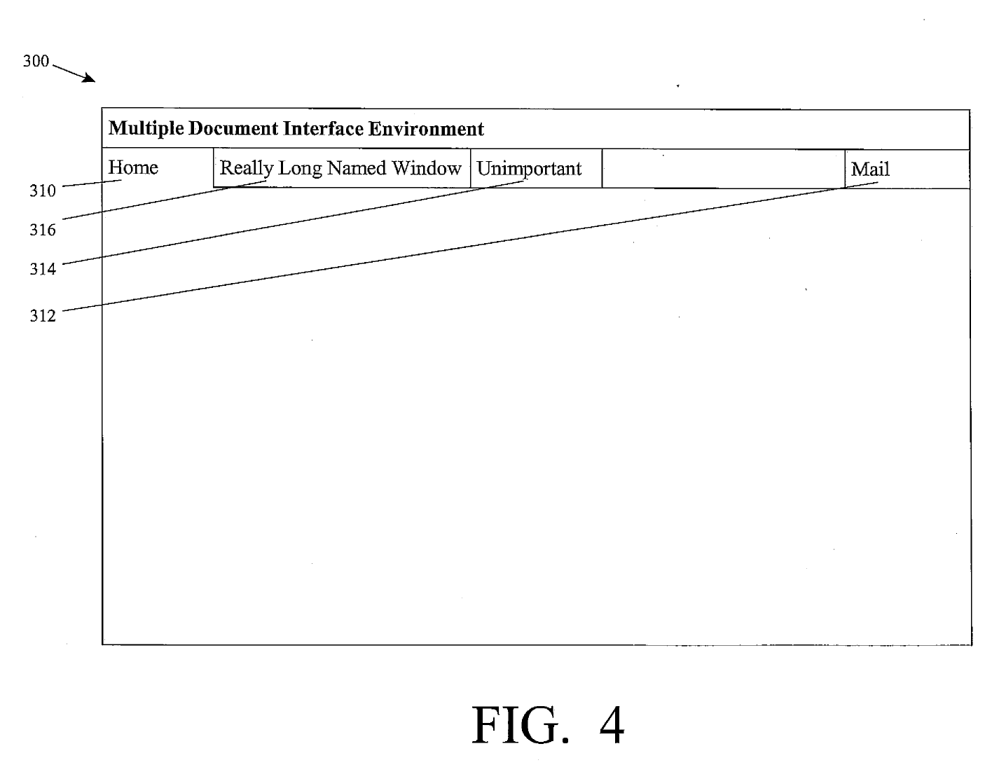

Referring now to FIGS. 3 and 4, illustrated are managed MDI environments 200, 300 that have been rendered by custom control renderer 46 using the specifications provided by control customizer 44. In FIG. 3, the tab corresponding to the mail window 214 has been located in the second to the leftmost spot, the tab corresponding to the really long named window 216 has been located in the third to the leftmost spot and the tab corresponding to the unimportant window 212 has been located in the furthest from the leftmost slot. This could be accomplished using one or a combination of specifications provided by control customizer 44. For example, user 16 could have specified that the home tab 210 and the mail tab 214 always be located in positions number one and two in a hierarchy that begins at the leftmost edge of the window. In this scenario, unimportant tab 212 may be specified as always being the rightmost tab in the hierarchy regardless of the other intervening tabs. Alternatively, home tab 210 may be specified as always being in the absolute leftmost position in the window while the mail tab 214 is specified as being the tab just to the left of the home tab 210. In any case, really long name window tab 216 has also been expanded to allow user 16 to read the entirety of the text. Similarly, the size of this or any other window could have been reduced.

In FIG. 4, custom control renderer 46 has placed the home tab 310 in the leftmost position; the really long named window tab 316 in the second to leftmost position and the unimportant tab 314 in the rightmost position in the hierarchy while the mail tab 312 has been positioned adjacent to the rightmost edge of the window. The mail tab 312 as illustrated, is positioned using an absolute location specification from the control customizer 44, while the other tabs 310, 314, 316 may be placed using any type of specification detailed above.

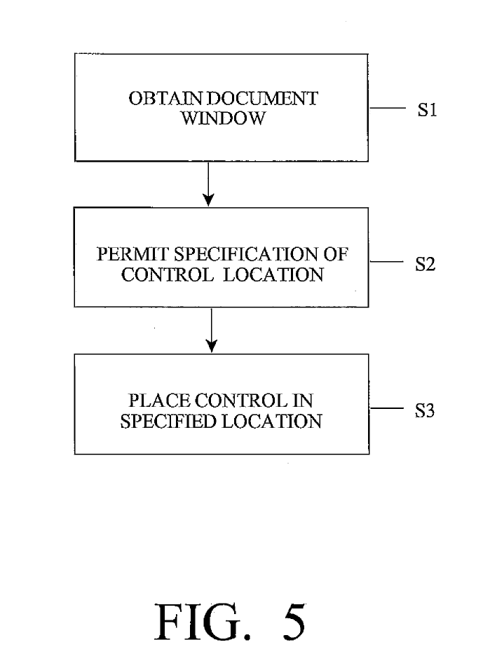

Turning now to FIG. 5, a flow chart of a method according to an embodiment of the present invention is depicted, which is described with reference to FIG. 1. In process S1, document window obtainer 42 obtains a document window in an MDI environment 100 (FIG. 2). MDI environment 100 includes at least one dynamically generated document window corresponding to an independently selected document and an associated control, such as a tab, for selecting the document window. In process S2, control customizer 44 permits user 16 to specify control options. Control options may include a location of a control and/or size of a control. In process S3, custom control renderer 46 places the control the specified location and/or renders it in the specified size.

While shown and described herein as a method and system for managing tabs in an MDI environment, it is understood that the invention further provides various alternative embodiments. For example, even though, in FIG. 1, MDI based application 38 and control management system 40 are illustrated as separate components, those skilled in the art should understand that many alternative configurations may be envisioned. For example, control management system 40 may be a component of MDI based application 38, a plug in to MDI based application 38 or a portion of an operating system for a machine on which MDI based application 38 is executed. In the case that control management system 40 is not integrated into MDI based application, control management system 40 may interact with MDI based application 38, or vice versa, through an application program interface (API) or by any other way that is now known or later developed.

In one embodiment, the invention provides a computer-readable/useable medium that includes computer program code to enable a computer infrastructure to manage tabs in an MDI environment. To this extent, the computer-readable/useable medium includes program code that implements the process of the invention. It is understood that the terms computer-readable medium or computer useable medium comprises one or more of any type of tangible embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer a service that manages tabs in an MDI environment. In this case, the service provider can create, maintain, support, etc., a computer infrastructure, such as computer infrastructure 12 (FIG. 1) that performs the process of the invention for one or more entities. In return, the service provider can receive payment from the entity(s) under a subscription and/or fee agreement and/or the service provider can receive payment from the sale of advertising content to one or more third parties.

In still another embodiment, the invention provides a computer-implemented method for managing tabs in an MDI environment. In this case, a computer infrastructure, such as computer infrastructure 12 (FIG. 1), can be provided and one or more systems for performing the process of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for managing a multiple document interface environment, comprising:
obtaining at least one dynamically generated document window, each document window corresponding to an independently selected document and having an associated control for selecting the document window;
obtaining a specified location of the associated control based on the document; and
placing the associated control in the specified location.

2. The method of claim 1, wherein the control is a tab.

3. The method of claim 1, further comprising:
obtaining a specified size of the control that is different from a default size; and
rendering the control of the specified size,
wherein the control is rendered in the specified size each time the control is displayed.

4. The method of claim 1, wherein the multiple document interface environment is a web browser.

5. The method of claim 1, wherein the obtaining the specified location includes at least one of: obtaining an absolute location in the window, obtaining a location relative to another control, and obtaining a location relative to a control order.

6. The method of claim 1, wherein the associated control is placed in the specified location each time the associated control is displayed.

7. A system for managing a multiple document interface environment, comprising:
a document window obtainer for obtaining at least one dynamically generated document window, each document window corresponding to an independently selected document and having an associated control for selecting the document window;
a control customizer for obtaining a specified location of the associated control based on the document; and
a custom control renderer for placing the associated control in the specified location.

8. The system of claim 7, wherein the control is a tab.

9. The system of claim 7,
wherein the control customizer obtains a specified size of the control that is different from a default size;
wherein the custom control renderer renders the control of the specified size, and
wherein the control is rendered in the specified size each time the control is displayed.

10. The system of claim 7, wherein the multiple document interface environment is a web browser.

11. The system of claim 7, wherein the specified location includes at least one of: an absolute location in the window, a location relative to another control, and a location relative to a control order.

12. The system of claim 7, wherein the custom control renderer places the associated control in the specified location each time the associated control is displayed.

13. A program product stored on a computer readable medium for managing a multiple document interface environment, the computer readable medium comprising:
program code for obtaining at least one dynamically generated document window, each document window corresponding to an independently selected document and having an associated control for selecting the document window;
program code for obtaining a specified location of the associated control based on the document; and
program code for placing the associated control in the specified location.

14. The program product of claim 13, wherein the control is a tab.

15. The program product of claim 13, further comprising:
program code for obtaining a specified size of the control that is different from a default size; and
program code for rendering the control of the specified size,
wherein the control is rendered in the specified size each time the control is displayed.

16. The program product of claim 13, wherein the multiple document interface environment is a web browser.

17. The program product of claim 13, wherein the specified location includes at least one of: an absolute location in the window, a location relative to another control, and a location relative to a control order.

18. The program product of claim 13, wherein the program code for placing places the associated control in the specified location each time the associated control is displayed.

19. A method for deploying a system for managing a multiple document interface environment, comprising:
providing a computer infrastructure being operable to:
obtain at least one dynamically generated document window, each document window corresponding to an independently selected document and having an associated control for selecting the document window;
obtain a specified location of the associated control based on the document; and
place the associated control in the specified location.

20. The method of claim 19, wherein the obtaining the specified location includes at least one of: obtaining an absolute location in the window, obtaining a location relative to another control, and obtaining a location relative to a control order.
